(19) United States
(12) Patent Application Publication
(10) Pub. No.: US 2012/0164421 A1
(43) Pub. Date: Jun. 28, 2012

(54) Polymeric Films And Methods To Manufacture Same

(76) Inventors: Zhi-Yi Shen, Shanghai (CN); Xiao-Chuan Wang, Shanghai (CN); Achiel Josephus Van Loon, Shanghai (CN)

(21) Appl. No.: 13/393,700

(22) PCT Filed: Nov. 9, 2009
(86) PCT No.: PCT/CN2009/001240

§ 371 Date: Mar. 1, 2012

(51) Int. Cl. B32B 7/02; B29C 49/16; B29C 49/04

(52) U.S. Cl. 428/218; 264/555; 264/510

(57) ABSTRACT

Polymeric films are provided. The films comprise an ethylene-derived resin that has a density of about 0.905 to about 0.945 g/cm³, a compositional distribution breadth index (CDBI) of at least 50%, a melt index (MI) of about 0.1 to about 5.0 g/10 min and a branching index (g′) of greater than about 0.7. The film may further comprise a propylene-derived resin having a density of about 0.86 to about 0.91 g/cm³. The films have excellent mechanical and optical properties and double-bubble extrusion processability.

### FIELD OF THE INVENTION

The present invention relates to polymeric films. More particularly, the invention relates to polymeric films comprising ethylene-derived resins that are formed using double-bubble extrusion processes.

### BACKGROUND OF THE INVENTION

Polymeric films are used in a variety of applications, such as for shrink wrapping films, display wrapping films, flexible overwrap and packaging, pre-made bags, printing films, etc. Processability as well as the mechanical and optical properties of these films varies considerably according to their composition and method of manufacture.

In double-bubble film processes, films comprising single-site (e.g., metallocene)-catalyzed polyethylene (m-PE) resins, for example, those commercially available from ExxonMobil Chemical Company under the trade designation EXCEED™, exhibit excellent mechanical properties and optical properties.

However, films containing EXCEED™ m-PE resin that are formed using double-bubble extrusion have exhibited difficult processability in first bubble and poor bubble stability in second bubble.

By way of further background, U.S. Pat. No. 6,423,420 entitled “Oriented Coextruded Films” (Brant et al) discloses a multilayer film comprising a polypropylene (PP) core layer and an EXCEED™ ethylene copolymer. The film layers are uniaxially or biaxially oriented using a tenter-frame process.

That said, what is needed in the art is a polymeric composition that may be used in double-bubble extrusion processes to form films exhibiting excellent processability and bubble stability as well as excellent mechanical and optical properties.

### SUMMARY OF THE INVENTION

In one aspect, this disclosure relates to multilayer films having: (a) a first layer A comprising a propylene-derived resin that has a density of about 0.86 to about 0.91 g/cm³;

and (b) a second layer B comprising an ethylene-derived resin that has a density of about 0.905 to about 0.945 g/cm3, a compositional distribution breadth index (CDBI) of at least 50%, a melt index (MI) of about 0.1 to about 5.0 g/10 min and a branching index g′ of greater than about 0.7. In various embodiments, the film is formed using double-bubble extrusion.

In another aspect, this disclosure relates to a method for forming a thermoplastic film comprising: (i) extruding an ethylene-derived resin to form an extrudate; (ii) inflating the extrudate to form a first bubble; (iii) cooling and collapsing the first bubble to form a primary tube; (iv) heating the primary tube to make the film soft; (v) inflating the primary tube to form a second bubble that at least partially biaxially orients the film; and (vi) cooling and collapsing the second bubble. The ethylene-derived resin may have a density of about 0.905 to about 0.945 g/cm³, a compositional distribution breadth index (CDBI) of at least 50%, a melt index (MI) of about 0.1 to about 5.0 g/10 min and a branching index (g′) of greater than about 0.7.

The films may be used in a variety of applications such as shrink film, display film, bundling film, flexible overwrapping film, flexible packaging, pre-made bags, printed films, personal care films, and surface protection applications, among other applications. These and other features, aspects, and advantages of the present disclosure will become better understood with regard to the following description and appended claims.

### BRIEF DESCRIPTION OF THE FIGS.

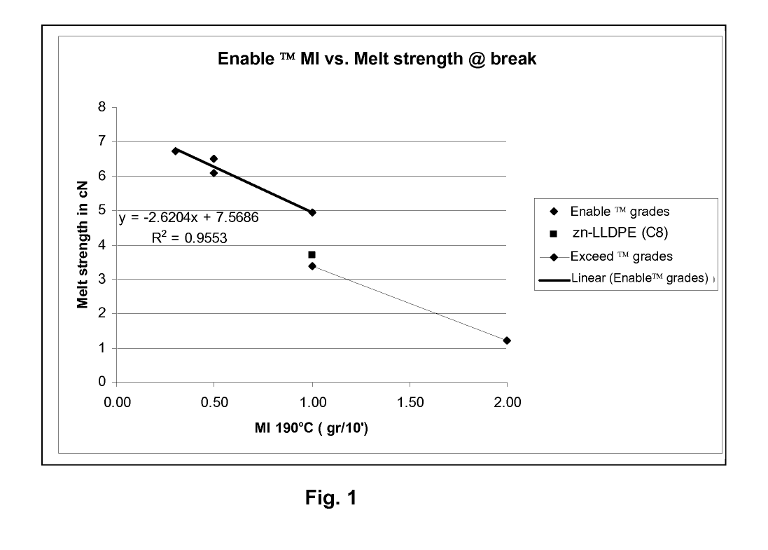

FIG. 1 is a chart showing melt index vs. melt strength of exemplary resins;

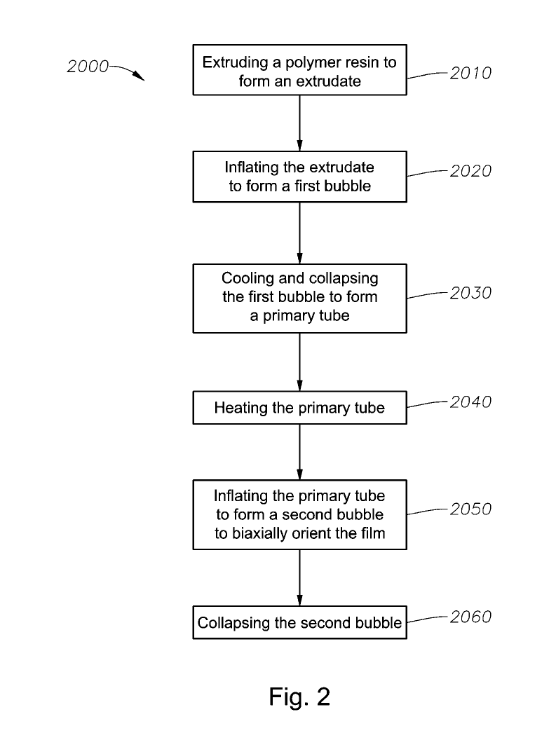

FIG. 2 is a flowchart of an exemplary double-bubble extrusion process; and

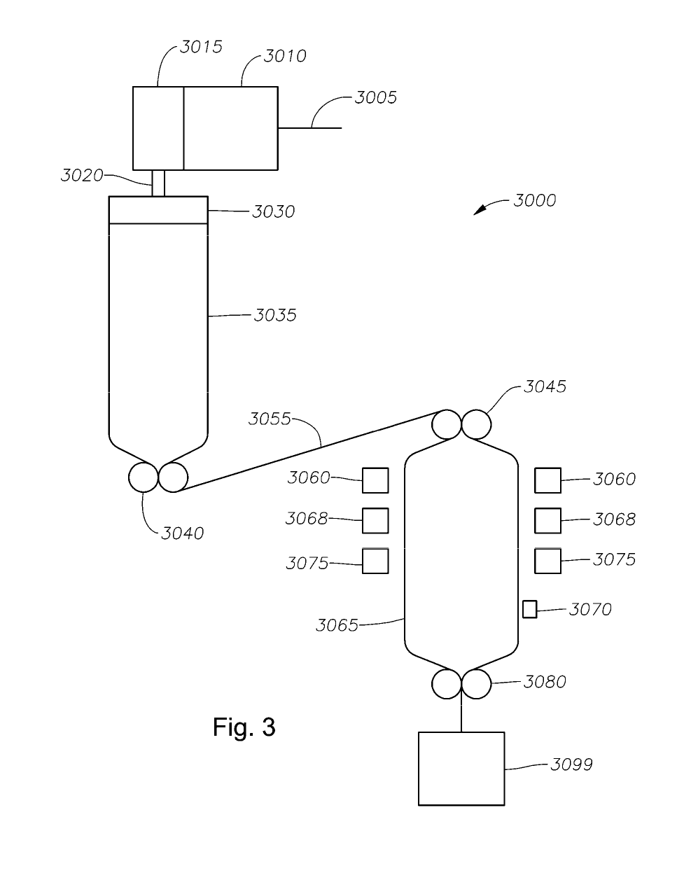

FIG. 3 is a schematic of an exemplary double-bubble extrusion process.

### DETAILED DESCRIPTION OF THE INVENTION

Various specific embodiments, versions and examples of the invention will now be described, including preferred embodiments and definitions that are adopted herein for purposes of understanding the claimed invention. While the following detailed description gives specific embodiments, those skilled in the art will appreciate that these embodiments are exemplary only, and that the invention can be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

That said, films having excellent: (a) mechanical and optical properties; and (b) double-bubble extrusion processability are described herein. As discussed in more detail below, the films include an ethylene-derived resin. In various embodiments, the films further include one or more additional polymeric resins and/or may be formed through double-bubble extrusion.

### Ethylene-Derived Resin

The ethylene-derived resin may be any composition comprising at least 80 wt % of ethylene moieties based upon total weight of the ethylene-derived resin. In various embodiments, the ethylene-derived resin comprises a polyethylene, such as a high density polyethylene (HDPE) having a density of greater than about 0.941 g/cm³, medium density polyethylene (MDPE) having a density of about 0.930 to about 0.940 g/cm³, low density polyethylene (LDPE) having a density of about 0.910 to about 0.930 g/cm³, very low density polyethylene (VLDPE) having a density of about 0.880 to about 0.909 g/cm³, or combinations thereof In a preferred embodiment, the ethylene-derived resin comprises a linear low density polyethylene (LLDPE) having a density of about 0.905 to about 0.945 g/cm³.

In various embodiments, the ethylene-derived resin has one or more of the following properties:

(a) a density (sample preparation according to ASTM D-4703, and the measurement according to ASTM D-1505) of about 0.905 to about 0.945 g/cm³;

(b) a Melt Index (“MI”, ASTM D-1238, 2.16 kg, 190° C.) of about 0.1 to about 5.0 g/10 min, or about 0.1 to about 3.0 g/10 min, or about 0.1 to about 1.0 g/10 min;

(c) a Melt Strength (“MS”; measured as described below) of greater than about 2.0 cN, or greater than about 4.0 cN;

(d) a relation between Melt Index in g/10 min and Melt Strength in cN (as illustrated in FIG. 1) according to the formula:

MS=−2.6204*MI+7.5686

(e) a Melt Index Ratio (“MIR”, I_{21.6} (190° C., 21.6 kg)/I_{2.16} (190° C., 2.16 kg)) of about 25 to about 80, or about 30 to about 45, or wherein the MIR can be determined according to the following formula:

ln(MIR)=−18.20−0.2634 ln(MI, I_{2.16})+23.58×[density, g/cm³];

(f) a Compositional Distribution Breadth Index (“CDBI”) of at least 50%, or at least 70%. The CDBI may be determined using techniques for isolating individual fractions of a sample of the resin. One such technique is Temperature Rising Elution Fraction (“TREF”), as described in Wild, et al., J. Poly. Sci., Poly. Phys. Ed., vol. 20, p. 441 (1982), which is incorporated herein by reference for this purpose;

(g) a molecular weight distribution (“MWD”) of greater than about 1.0, or about 2.0 to about 5.5. MWD is measured using a gel permeation chromatograph (“GPC”) equipped with a differential refractive index (“DRI”) detector; and

(h) a branching index (“g′”) of greater than about 0.7. Branching Index is an indication of the amount of branching of the polymer and is defined as g′=[Rg]²_{br}/[Rg]²ₗᵢₙ. “Rg” stands for Radius of Gyration, and is measured using Multi-Angle Laser Light Scattering (“MALLS”) equipment. “[Rg]_{br}” is the Radius of Gyration for the branched polymer sample and “[Rg]ₗᵢₙ” is the Radius of Gyration for a linear polymer sample. It is well known in the art that as the g′ value decreases, long-chain branching increases.

The ethylene-derived resin may be a homopolymer or copolymer, such as a random copolymer. As used herein, the term “copolymer” includes polymers having more than two types of monomers, such as terpolymers. In various embodiments, the ethylene-derived resin may comprise a blend of one or more polymers.

In various embodiments, the ethylene-derived resin is a copolymer of ethylene and one or more comonomers. In various embodiments, the comonomer is another α-olefin. Suitable α-olefins include, for example, C₃-C₂₀ α-olefins, or C₃-C₁₀ α-olefins, or C₃-C₈ α-olefins. The α-olefin comonomer may be linear or branched, and two or more comonomers may be used, if desired. Examples of suitable α-olefin comonomers include propylene, butene, 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene. Specifically, but without limitation, the combinations of ethylene with a comonomer may include: ethylene propylene, ethylene butene, ethylene 1-pentene; ethylene 4-methyl-1-pentene; ethylene 1-hexene; ethylene 1-octene; ethylene decene; ethylene dodecene; ethylene 1-hexene 1-pentene; ethylene 1-hexene 4-methyl-1-pentene; ethylene 1-hexene 1-octene; ethylene 1-hexene decene; ethylene 1-hexene dodecene; ethylene 1-octene 1-pentene; ethylene 1-octene 4-methyl-l-pentene; ethylene 1-octene 1-hexene; ethylene 1-octene decene; ethylene 1-octene dodecene; combinations thereof and like permutations. In one particular embodiment, the ethylene-derived resin is up to 80 wt % derived ethylene and up to 20 wt %, 1-hexene.

In various embodiments, the ethylene-derived resin is substantially pure. “Substantially pure” means the ethylene-derived resin is substantially free of (i.e., <1% by weight of the resin) ethylene vinyl acetate (“EVA”), low density polyethylene (“LDPE”) and/or Ziegler-Natta-catalyzed high α-olefin linear low density polyethylene (“ZN HAO LLDPE”). In an exemplary embodiment, the ethylene-derived resin is a single grade.

The ethylene-derived resin can be also blended with, for example, one or more of: LDPE, MDPE, LLDPE, mLLDPE, ethyl vinyl acetate (EVA), propylene homopolymer propylene-ethylene copolymer and propylene-ethylene-butene terpolymers but not limited to these specific polymers.

In various embodiments, the ethylene-derived resin is single-site (e.g., metallocene) catalyzed. Suitable metallocene catalysts include any compound having a Group 3, 4, 5 or 6 transition metal (M) and one or more substituted or unsubstituted cyclopentadienyl (Cp) moieties (typically two Cp moieties).

In an embodiment, the metallocene catalyst has two bridged cyclopentadienyl groups, preferably with the bridge consisting of a single carbon, germanium or silicon atom so as to provide an open site on the catalytically active cation.

In various embodiments, the metallocene catalyst is substantially devoid of a metallocene having a pair of pi bonded ligands (cyclopentadienyl compounds) which are not connected through a covalent bridge. In other words, no such metallocene is intentionally added to the catalyst, or preferably, no such metallocene can be identified in such catalyst, and the process uses substantially a single metallocene species comprising a pair of pi bonded ligands at least one of which has a structure with at least two cyclic fused rings (e.g., indenyl rings). In various embodiments, the metallocene comprises a silicon bridge connecting two polynuclear ligands pi bonded to the transition metal atom.

For example, the metallocene catalyst may have the structure of:

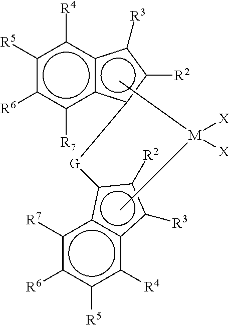

where M is a group 3, 4, 5, or 6 transition metal atom, preferably a Group 4 transition metal atom, preferably a metal selected Ti, Zr and Hf, preferably Zr. R₁, R₂, R₃, R₄, R₅, R₆ and R₇ are, independently, hydrogen or a C₁ to C₂₀ alkyl group, and X is a halogen or hydrocarbyl group, preferably Cl, Br, F, I, methyl, ethyl, propyl, butyl, phenyl and benzyl group. G may be selected from the following structures:

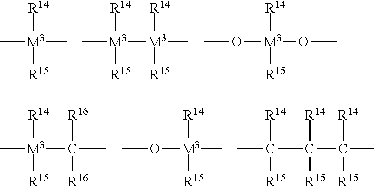

where M³ may be any of carbon, silicon, germanium, oxygen, and tin, and R¹⁴, R¹⁵ and R¹⁶ are each, independently, may be any of hydrogen, halogen, C₁-C₂₀ alkyl groups.

In various embodiments, the metallocene catalyst is activated with a suitable co-catalyst in order to yield an “active metallocene catalyst,” i.e., an organometallic complex with a vacant coordination site that can coordinate, insert, and polymerize olefins. Suitable co-catalysts include alkyl-alumoxanes, such as methyl-alumoxane (MAO), such as is described in U.S. Pat. No. 5,324,800 entitled “Process and Catalyst for Polyolefin Density and Molecular Weight Control” (Welborn and Ewen) herein incorporated by reference for this purpose.

In various embodiments, there are substantially no scavengers in the formation of the LLDPE that may interfere with the reaction between the vinyl end unsaturation of polymers formed and the open active site on the cation. “Substantially no scavengers” means that there are less than 100 ppm by weight of scavengers (e.g., aluminum alkyl scavengers or Lewis acid scavengers) present in the feed gas, or preferably, no intentionally added scavenger other than that which is present on the catalyst support.

The ethylene-derived resins described herein are not limited by any particular method of preparation. In various embodiments, the ethylene-derived resin is produced by a continuous gas phase process. For example, a metallocene-catalyzed linear low density polyethylene (m-PE) may be formed by continuously circulating a feed gas stream containing monomer and inerts to thereby fluidize and agitate a bed of polymer particles by adding metallocene catalyst to the bed and removing polymer particles, in which:

(a) the catalyst comprises at least one bridged bis-cyclopentadienyl transition metal and an alumoxane activator on a common or separate porous support. The catalyst may be supported in any matter known in the art. For example, silica may be used. The catalyst may be homogeneously distributed in the silica pores;

(b) the feed gas contains substantially no scavengers;

(c) the temperature in the bed is no more than 20° C. less than the polymer melting temperature as determined by differential scanning calorimetry (“DSC”), at an ethylene partial pressure in excess of 60 pounds per square inch absolute (414 Kpa); and

(d) the removed polymer particles have an ash content of transition metal of less than 500 wt. ppm, the MI is less than 10 g/10 min, the MIR is at least 35 with the polymer having substantially no detectable end unsaturation as determined by hydrogen nuclear magnetic resonance (“HNMR”). “Substantially no detectable end chain unsaturation” means the polymer has vinyl unsaturation of less than 0.1 vinyl groups per 1000 carbon atoms, e.g., less than 0.05 vinyl groups per 1000 carbon atoms, e.g., less than 0.01 vinyl groups per 1000 carbon atoms or less.

In an embodiment, the ethylene derived resin is formed under steady state polymerization conditions that are not likely to be provided by batch reactions in which the amounts of catalyst poisons can vary in the production of the batch. The ethylene-derived resin may also be cross-linked.

In addition to those discussed above, ethylene-derived polymers that are useful in this invention include those disclosed in U.S. Pat. No. 6,255,426, entitled “Easy Processing Linear Low Density Polyethylene” (Lue), which is hereby incorporated by reference in its entirety, and includes ethylene-derived resins commercially available from ExxonMobil Chemical Company in Houston, Tex., such as those sold under the trade designation ENABLE™.

### Additional Polymeric Resin

As discussed above, the films disclosed herein may comprise one or more additional polymeric resins. In various embodiments, the additional polymeric resin comprises a resin derived from propylene (propylene-derived resin), such as polypropylene (PP). As used herein, “propylene-derived resin” means a resin comprising at least 70 wt % of propylene moieties based upon total weight of the resin used. The additional polymeric resin may have one or more of the following properties:

(a) a density of about 0.86 to about 0.91 g/cm³; and

(b) a MFR (Melt Flow Rate; ASTM D-1238, Test condition for Polypropylene resin: 230° C., 2.16 kg) of about 0.5 to about 50.0 g/10 min.

The additional polymeric resin may be a homopolymer or copolymer, such as a random copolymer. In an embodiment, the polymeric resin comprises a polypropylene/α-olefin copolymer. In various embodiments, it is a terpolymer.

Polymer blends are also contemplated. For example, the additional polymeric resin may comprise a blend of one or more polypropylene resins, or one or more polypropylene resins with one or more additional resins. For example, one or more resins commercially available from ExxonMobil Chemical Company that sold under the trade designations EXCEED™, EXACT™, ACHIEVE™, EXXTRAL™, EXXPOL™ ENHANCE™ and VISTAMAXX™ and those commercially available from Lyondell Basell Industries under the trade designation ADSYL™ may be used but are not limited to these specific polymers.

The additional polymeric resins described herein are not limited by any particular method of preparation and may be formed using any process known in the art. Ziegler-Natta and/or single-site-catalyzed resins may be used.

In an embodiment, the polymeric film comprises an ethylene-derived layer and one or more layers formed of the additional polymeric resin. It will be understood that the film may comprise any number of ethylene-derived layers and additional polymeric resin layers. For example, one or more ethylene-derived layers (B) and additional polymeric resin layers (A) may be arranged in any number of layer configurations, e.g., (A/B/A) or (A/A/B/A/A) or (A/B/B/B/A) or (A/B/B/B/B/B/A) or (A/A/B/B/B/A/A) or (A/A/A/B/A/A/A). “Located between” means occupying, in whole or in part, the space separating the additional polymeric resins, but does not necessarily mean the ethylene-derived layer is adjacent to, or contiguous with, the additional polymeric resin layers.

In an embodiment, the polymeric film may only comprise ethylene-derived layers (B) e.g. (B/B/B) or (B/B/B/B/B). In an embodiment, the polymeric film comprises at least two layers each consisting essentially of an ethylene-derived resin.

In various embodiments, the additional polymeric resin layers are substantially the same. In other embodiments, the additional polymeric layers differ in one or more of thickness, chemical composition, density, melt index, CDBI, MWD, additives used, and/or other properties.

### Additives

The resins described herein may comprise one or more additives. Additives include, for example, antioxidants, antistatic agents, ultraviolet light absorbers, plasticizers, pigments, dyes, antimicrobial agents, anti-blocking agents, stabilizers, lubricants (e.g., slip agents such as slip MB), processing aids, and the like.

### Film Formation

In various embodiments, the films described herein may be formed using various processes known in the art.

In an embodiment, the film is formed using double-bubble extrusion. As illustrated in the embodiment depicted in FIG. 2, double-bubble extrusion process 2000 comprises: extruding or coextruding a polymer resin to form an extrudate (Step 2010); inflating or expanding the extrudate to form a first bubble (Step 2020); collapsing the first bubble to form primary tube (Step 2030); heating the primary tube to make it soft (Step 2040), inflating or expanding the primary tube to form a second bubble to biaxially orient the film (Step 2050); and collapsing the second bubble (Step 2060).

Regarding Step 2010, the polymer resin may comprise an ethylene-derived resin alone or in combination with one or more additional polymeric resins as described above.

The polymer resin can be extruded using any technique known in the art. The ethylene-derived resin and additional polymeric components may be blended and extruded or may be separately extruded and then joined for coextrusion. In an embodiment, the resin is preheated and/or heated within the extruder to a temperature suitable to cause the polymer to soften or melt (e.g., 120 to 230° C.). The heat may be provided using any known technique or equipment. Moreover, the extruder may have a constant temperature or may have a temperature gradient ranging about 140° C. to about 230° C., or about 150° C. to about 200° C. Table 1A below illustrates an exemplary core layer extrusion temperature profile having heat zones 1-5, where the heat zones are evenly spaced along the length of the extruder with zone 1 closest to the resin feed and zone 5 closest to the die. Table 1B illustrates two skin layer extrusion temperature profiles having heat zones 1-4, where the heat zones are evenly spaced along the length of the extruder with zone 1 closest to the resin feed and zone 4 closest to the die.

TABLE 1A
Core Layer Extrusion Temperature Profile

| | Zone 1 | Zone 2 | Zone 3 | Zone 4 | Zone 5 |
|---|---|---|---|---|---|
| Temp. ° C. | 165 | 175 | 165 | 160 | 155 |

TABLE 1B
Skin Layer Extrusion Temperature Profile

| | Zone 1 | Zone 2 | Zone 3 | Zone 4 |
|---|---|---|---|---|
| Temp. ° C. | 165 | 180 | 165 | 165 |
| Temp. ° C. | 165 | 175 | 165 | 165 |

In operation, the extruder has an extrusion screw that rotates within the extruder to force the molten polymer through a die to form an extrudate having a fixed cross sectional profile (e.g., tubular). In an embodiment, the die is annular, with die gap 0.5 to 3.0 mm However, it will be understood that dies of various configurations may be used. In an embodiment, the die is operable to maintain a temperature of about 150 to about 200° C., or about 160-190° C.

Regarding Step 2020, the extrudate may be expanded into the first bubble using any suitable technique or equipment. For example, air may be injected through the die orifice in sufficient quantity to cause the resin to expand into a bubble of a desired diameter. The film thickness is controlled by Blow Up Ratio (BUR), take-off speed and output. The film thickness may be about 200 to about 750 μm.

Regarding Step 2030, the first bubble may be cooled and collapsed using any suitable technique or equipment to form a primary tube. For example, the bubble may be quenched by using water, for example, in the form of a cascade spray and/or immersion bath and/or one or more rollers may be used to flatten the bubble. Cooling may be done before bubble collapsed.

Regarding Step 2040, the primary tube may be heated. Any suitable technique may be used to heat the resin. For example, one or more radiant heaters or ovens may be used. In one particular embodiment, the primary tube is fed through a series of ovens so as to gradually increase the temperature of the tube. The ovens may be uniformly heated or set at different temperatures. In one embodiment, the oven temperatures vary in small increments, such as about +/−10° C., or about +/−5° C., or about +/−2° C. In accordance with an aspect of the invention, the crystallinity of the first bubble will define the required oven temperature settings. The higher the crystallinity, the higher the oven temperature required.

In accordance with an embodiment, the tube is heated to a temperature such that it (i) has a suitable melt strength to create and maintain the second bubble; and (ii) is drawable and orientable when stretched.

The primary tube may be also cross linked by gamma or beta irradiation before heating and inflation steps. After cross linking, the first bubble may have required suitable melt strength to form and maintain the second bubble.

Regarding Step 2050, the second bubble may be formed after heating the primary tube and introducing air to inflate the tube.

In an embodiment, the film is oriented (in whole) in both the machine direction (MD) and transverse direction (TD).

The orientation is defined by a combination of the output of the extruders, the winder speed and the width of the secondary bubble versus the primary bubble. Regarding Step 2060, the second bubble may be quenched and then collapsed using one or more rollers.

In various embodiments, the double-bubble extrusion process may further comprise one or more of: (i) annealing the film; (ii) slitting the film to form a plurality of films; and/or (iii) winding the film onto a roller.

FIG. 3 is a schematic illustrating an embodiment of a double-bubble extrusion system 3000. As shown, polymer resin (e.g., ethylene-derived resin) 3005 is fed alone or in combination with one or more additional polymeric resins into extruder 3010 to form an extrudate. In other embodiments, one or more other extruders (e.g., coextruders) can be used to feed die 3015. The extrudate is then forced through die 3015 to form resin tube 3020. Resin tube 3020 is quenched using water ring 3030, which provides chilled water on the outer surface of resin tube 3020. Downwardly-extending first bubble 3035 is then formed by introducing air into the interior of resin tube 3020. First bubble 3035 is collapsed using rollers 3040 (and optionally quenched in water) and 3045 to form film composition 3055. Heat is applied to film composition 3055 using heaters 3060. Air is forced into the interior of film composition 3055 to form downwardly-extending second bubble 3065 that orients the film in both the MD and TD (biaxial orientation). The film composition is cooled using the ovens 3068 as well as air cooling rings 3075 and collapsed using rollers 3080. One or more thickness scanners 3070 monitors the thickness of second bubble 3065. The film may be wound onto roll 3099.

The above-described processes are intended for illustrative purposes only. Other useful double-bubble extrusion techniques are disclosed, for example, in U.S. Pat. No. 6,423,420 entitled “Oriented Extruded Films” (Brant et al.) and U.S. Pat. No. 3,456,044 entitled “Biaxial Orientation” (Pahlke), which are herein incorporated by reference for this purpose.

### Film Properties

In accordance with various embodiments, the films disclosed herein have one or more of the following properties (as determined by the procedures described herein):
(a) a Tensile at Break (MD/TD) of about 20 to about 200 MPa;
(b) an Elongation at Break (MD/TD) of about 40 to about 200%;
(c) a 1% Secant Modulus (MD/TD) of about 300 to about 1000 MPa;
(d) a Haze of about 1 to about 10%;
(e) an Elmendorf Tear (MD/TD) of about 0.01 to about 3 g/μm;
(f) Shrinkage (MD/TD) of about 20 to about 90%; and
(g) a Dart Impact Strength of about 5 to about 50 g/μm.

The film may be any thickness according to the desired properties of the film. For example, the film thickness may be about 1 to about 50 μm.

Moreover, the film may have any ratio of thickness between the layers. For example, a film comprising an ethylene-derived resin located between two additional polymeric resins may have a thickness distribution of about 5/90/5 to about 45/10/45, or about 10/80/10, or about 15/70/15.

### EXAMPLES

The advantages of the films described herein will now be further illustrated with reference to the following non-limiting examples.

### Properties and Materials

The properties used in the claims and the Examples are determined as follows:

Tensile at Break, Elongation at Break and 1% Secant Modulus were determined by a test method based on ASTM D-882 using a Zwick™ testing machine;

Elmendorf Tear was determined by a test method per ASTM D-1922;

Shrinkage was measured by re-heating of the film samples on a horizontal plane. The temperature is at 150° C. Silicone oil was applied between the film samples and the heated surface to prevent the samples from sticking to the heating plate and allowing a free shrinkage movement. The reported shrinkage is the so-called “cold shrink” of the film, as the shrink was measured on the cooled down shrinked sample;

Dart Impact Strength was determined per ASTM D-1709;

Haze was determined per ASTM D-1003;

Melt Index (MI) and Melt Flow Rate (MFR) were determined per ASTM D-1238; and

Melt Strength/extensional viscosity was determined using the Rheotens 71-97 in combination with the Rheograph 2002 as described: (1) Rheograph 2002 has: temperatures of 190° and 230° C., die: 30/2, piston speed: 0.178 mm/s, shear rate: 40.050 sec-1, wheels: grooved, (2) Strand: length: 100 mm, V₀: 10 mm/s, (3) Rheotens: gap: 0.7 mm, acceleration: 12.0 mm/s². For each material, several measurements were performed. The complete amount of material present in the barrel of the Rheograph is extruded through the die and is being picked up by the rolls of the Rheotens. Once the strand is placed between the rolls, the roll speed is adjusted till a force 0 is measured once the strand touches the ground. This beginning speed Vs is the speed of the strand through the nip of the wheels at the start of the test. Once the test is started, the speed of the rolls is increased with a 12.0 mm/s² acceleration and the force is measured for each given speed. After each strand break, or strand slip between the rotors, the measurement is stopped and the material is placed back between the rolls for a new measurement, which is started when the strand again touches the ground. A new curve is recorded. Measuring continues until all material in the barrel is used. After testing, all the obtained curves are saved. Curves, which are out of line, are deactivated. The remaining curves, are cut at the same point at break or slip (maximum force measured), and are used for the calculation of a mean curve. The numerical data of this calculated mean curves are reported.

Table 2 provides a listing of materials used in the films of Example 1.

TABLE 2
Example Components

| Component | Brief Description | Commercial Source |
|---|---|---|
| EXCEED ™ 2018 CA (m- | Ethylene-hexene copolymer, MI = 2.0 g/10 min, | ExxonMobil |
| PE) | density = 0.918 g/cm³, metallocene- | Chemical Company |
| | catalyzed, UNIPOL ™ process | |
| ENABLE ™ 20-10CH (m- | Ethylene-hexene copolymer, MI = 1.0 g/10 min, | ExxonMobil |
| PE) | density = 0.920 g/cm³, metallocene- | Chemical Company |
| | catalyzed, Unipol ™ process | |
| ENABLE ™ 20-05CH (m- | Ethylene-hexene copolymer, MI = 0.5 g/10 min, | ExxonMobil |
| PE) | density = 0.920 g/cm³, metallocene- | Chemical Company |
| | catalyzed, UNIPOL ™ process | |
| ENABLE ™ 27-05CH (m- | Ethylene-hexene copolymer, MI = 0.5 g/10 min, | ExxonMobil |
| PE) | density = 0.927 g/cm³, metallocene- | Chemical Company |
| | catalyzed, UNIPOL ™ process | |
| zn-PE 1 | Ethylene-Octene copolymer, MI = 1.0 g/10 min, | Supplier 1 |
| | density = 0.920 g/cm³, Ziegler-Natta | |
| | catalyzed, solution polymerization process | |
| zn-PE 2 | Ethylene-Octene copolymer, MI = 1.0 g/10 min, | Supplier 2 |
| | density = 0.920 g/cm³, Ziegler-Natta | |
| | catalyzed, solution polymerization process | |
| ADSYL ™ 5C37F | Propylene-Ethylene-Butene Terpolymer, | LyondellBasell |
| | MFR = 5.5 (230° C., 2.16 kg), Density = | Group |
| | 0.902 | |

As used above, “UNIPOL™ process” refers to a polymerization process owned Univation Technologies, a joint venture between ExxonMobil Chemical Company and Dow Chemical Company for manufacturing olefin-based polymers, namely, polyethylene (PE) and polypropylene (PP). “Solution polymerization process” refers to a conventional polymerization process in which the monomers and the polymerization catalyst are dissolved in a liquid solvent at the beginning of the polymerization reaction.

### Example 1

Table 3A illustrates various properties and processing conditions of multilayer films formed using double-bubble coextrusion. The films have a polyethylene core layer and two polypropylene skin layers (polypropylene layer/polyethylene layer/polypropylene layer). The polyethylene layers are one of: (a) 96 wt % ENABLE™ m-PE and 4 wt % of slip MB based on total weight of the composition; and (b) 97 wt % zn-PE and 3 wt % of slip MB based on total weight of the composition. The polypropylene layers are terpolymer polypropylene and are the same for all films tested. The layer distribution is 1/5/1. The films were made on a 3-layer coextrusion double-bubble line with screw size: 65/75/65 mm, die diameter: 290 mm, die gap: 1.7 mm, throughput: 100 kg/hr, Blow Up Ratio: 5. The overall thickness of the film is 19 μm. As shown, in double bubble processes, ENABLE™ m-PE exhibits stronger mechanical properties than zn-PE. Tables 3B-3C illustrate the extrusion temperature settings (with the zones evenly spaced along the length of the extruder with zone 1 closest to the resin feed and zone 6 closest to the die) and oven temperature settings (where zones 1-4 are represented on FIG. 3 as element 3060 and zones 5-6 are represented as element 3068 and elements 1-7 proceed consecutively from the top to the bottom of element 3065. Zones 1-4 increase progressively in diameter. Zones 5 and 6 are the same diameter), respectively.

Legend for Tables 3A-3C

| | |
|---|---|
| Blend 1 | ADSYL ™ 5C37F/zn-PE 1 zn-PE 2 blending |
| | (50:50)/ADSYL ™ 5C37F |
| Blend 2 | ADSYL ™ 5C37F/ENABLE ™ 20-05CH/ADSYL ™ 5C37F |
| Blend 3 | ADSYL ™ 5C37F/ENABLE ™ 27-05CH/ADSYL ™ 5C37F |
| Blend 4 | ADSYL ™ 5C37F/ENABLE ™ 20-10CH/ADSYL ™ 5C37F |

TABLE 3A
Multilayer Films in Double-Bubble Extrusion

| | Film 1 | Film 2 | Film 3 | Film 4 |
|---|---|---|---|---|
| Tensile Strength at | 116.4 | 150.4 | 147.4 | 93.8 |
| Break (MD) (MPa) | | | | |
| Tensile Strength at | 133.0 | 157.3 | 144.3 | 115.6 |
| Break (TD) (MPa) | | | | |
| Elmendorf Tear | 0.3 | 0.3 | 0.2 | 0.4 |
| (MD) (g/μm) | | | | |
| Elmendorf Tear | 0.3 | 0.3 | 0.3 | 0.3 |
| (TD) (g/μm) | | | | |
| Dart Impact | 15.5 | 22.9 | 15.1 | 21.1 |
| Strength (g/μm) | | | | |
| Haze (%) | 3.2 | 5.6 | 4.7 | 5.4 |

TABLE 3B
Extrusion Temperature Settings (° C.)

| | Film 1 | | Film 2 | | Film 3 | | Film 4 | |
|---|---|---|---|---|---|---|---|---|
| | PP | PE | PP | PE | PP | PE | PP | PE |
| | Layers | Layers | Layers | Layers | Layers | Layers | Layers | Layers |
| Zone 1 | 166 | 160 | 166 | 160 | 166 | 160 | 166 | 160 |
| Zone 2 | 169 | 165 | 169 | 165 | 169 | 165 | 169 | 165 |
| Zone 3 | 172 | 167 | 172 | 167 | 172 | 167 | 172 | 167 |
| Zone 4 | 170 | 168 | 170 | 168 | 170 | 168 | 170 | 168 |
| Zone 5 | 168 | 170 | 168 | 170 | 168 | 170 | 168 | 170 |
| Zone 6 | N/A | 171 | N/A | 171 | N/A | 171 | N/A | 171 |

TABLE 3C
Oven Temperature Settings (° C.)

| | Blend 1 | Blend 2 | Blend 3 | Blend 4 |
|---|---|---|---|---|
| Zone 1 | 203 | 199 | 207 | 208 |
| Zone 2 | 280 | 283 | 289 | 295 |
| Zone 3 | 283 | 287 | 292 | 296 |
| Zone 4 | 298 | 300 | 303 | 310 |
| Zone 5 | 80 | 80 | 80 | 80 |
| Zone 6 | 80 | 80 | 80 | 80 |
| Zone 7 | 80 | 80 | 80 | 80 |

### Example 2

Tables 4A illustrates Tensile at break, Elmendorf tear, Haze and processing conditions of multilayer films formed using double-bubble extrusion. The films have a polyethylene core layer and two polypropylene skin layers (polypropylene layer/polyethylene layer/polypropylene layer). The polyethylene layers are one of EXCEED™ or ENABLE™ m-PE or zn-PE. The polypropylene layers are terpolymer polypropylene and are the same for all films tested. The layer distribution is 1/5/1. The overall thickness of the film is 25 μm. The films were made on a 3-layer coextrusion double-bubble line with screw size: 55/80/55 mm, motor size: 18.5/55/18.5 Kw, die diameter: 200 mm, die gap: 1.8 mm and throughput 130 kg/hr, Blow Up Ratio: 5. ENABLE™ m-PE exhibited excellent mechanical properties and optical properties as well as excellent processability. Tables 4B-4C illustrate the extrusion temperature settings (with the zones evenly spaced along the length of the extruder with zone 1 closest to the resin feed and zone 5 closest to the die) and oven temperature settings (where zones 1-4 are represented on FIG. 3 as element 3060 and zones 5-6 are represented as element 3068 and elements 1-7 proceed consecutively from the top to the bottom of element 3065. Zones 1-5 increase progressively in diameter. Zones 6 and 7 are the same diameter), respectively.

Legend for Tables 4A-4C

| | |
|---|---|
| Film 1 | ADSYL ™ 5C37F/zn-PE 1/ADSYL ™ 5C37F |
| Film 2 | ADSYL ™ 5C37F/EXCEED ™ 2018 CA/ADSYL ™ |
| | 5C37F (*) |
| Film 3 | ADSYL ™ 5C37F/ENABLE ™ 20-10CH/ADSYL ™ 5C37F |

TABLE 4A
Multilayer Films in Double-Bubble Extrusion

| Film Structure | Film 1 | Film 2 (*) | Film 3 |
|---|---|---|---|
| Tensile Strength at | 99 | 110 | 106.0 |
| Break (MPa) (MD) | | | |
| Tensile Strength at | 127.0 | 126 | 120 |
| Break (MPa) (TD) | | | |
| Elmendorf Tear | 0.7 | 0.7 | 0.6 |
| (g/μm) (MD) | | | |
| Elmendorf Tear | 0.7 | 0.7 | 0.6 |
| (g/μm) (TD) | | | |
| Haze (%) | 1.7 | 1.9 | 1.7 |
| Motor Current (A) | 115 | 115 | 104 |
| Melt Pressure | 27.72 | 25.08 | 23.52 |
| (MPa) | | | |
| Melt Temperature | 234 | 196 | 212 |
| (° C.) | | | |

(*) Second Bubble readily lost

TABLE 4B
Extrusion Temperature Settings (° C.)

| | | |
|---|---|---|
| Film 1 | Film 2 | Film 3 |

| | PP | PE | PP | PE | PP | PE |
|---|---|---|---|---|---|---|
| | Layer | Layer | Layer | Layer | Layer | Layer |
| Zone 1 | 165 | 180 | 165 | 163 | 165 | 165 |
| Zone 2 | 175 | 170 | 175 | 170 | 175 | 175 |
| Zone 3 | 165 | 165 | 165 | 156 | 165 | 165 |
| Zone 4 | 165 | 165 | 165 | 155 | 165 | 160 |
| Zone 5 | N/A | 170 | N/A | 145 | N/A | 155 |

TABLE 4C
Oven Temperature Settings (° C.)

| | Film 1 | Film 2 | Film 3 |
|---|---|---|---|
| Zone 1 | 208 | 220 | 215 |
| Zone 2 | 213 | 224 | 220 |
| Zone 3 | 260 | 250 | 267 |
| Zone 4 | 265 | 256 | 272 |
| Zone 5 | 255 | 251 | 262 |
| Zone 6 | 125 | 128 | 132 |
| Zone 7 | 120 | 123 | 127 |

The embodiments and tables set forth herein are presented to best explain the present invention and its practical application and to thereby enable those skilled in the art to make and use the invention. However, those skilled in the art will recognize that the foregoing descriptions and tables have been presented for the purpose of illustration and example only. The description as set forth is not intended to be exhaustive or to limit the invention to the precise form disclosed. Many modifications and variations are possible in light of the above teaching without departing from the spirit and scope of the claims.

1. A film comprising:
a first layer A comprising a propylene-derived resin, the propylene-derived resin having a density of about 0.86 to about 0.91 g/cm³; and
a second layer B comprising an ethylene-derived resin, the ethylene-derived resin having:
a density of about 0.905 to about 0.945 g/cm³;
a compositional distribution breadth index (CDBI) of at least 50%;
a melt index (MI) of about 0.1 to about 5.0 g/10 min; and
a branching index (g′) of greater than about 0.7.

2. The film of claim 1, wherein the ethylene-derived resin has a molecular weight distribution (MWD) of greater than about 1.0.

3. The film of claim 1, wherein the ethylene-derived resin a melt index ratio (MIR) of about 25 to about 80.

4. The film of claim 1, wherein the ethylene-derived resin has a MIR of about 30 to about 45.

5. The film of claim 1, wherein the ethylene-derived resin has a CDBI of at least 70%.

6. The film of claim 1, wherein the ethylene-derived resin has a melt strength (MS) of greater than about 4 cN.

7. The film of claim 6, wherein the ethylene-derived resin has a melt index of about 0.1 to about 1.0 g/10 min.

8. The film of claim 7, wherein the ethylene-derived resin has a melt index (MI) and a melt strength (MS) relationship according to the following formula:
MS=−2.6204*MI+7.5686.

9. The film of claim 1, wherein the ethylene-derived resin is linear low density polyethylene (LLDPE).

10.-13. (canceled)

14. The film of claim 9, wherein the LLDPE is blended with one or more of:
LDPE, MDPE, LLDPE, metallocene-catalyzed linear low density polyethylene (mLLDPE), ethyl vinyl acetate (EVA), propylene homopolymer propylene-ethylene copolymer and propylene-ethylene-butene terpolymers.

15. (canceled)

16. The film of claim 1, wherein the propylene-derived resin of the first layer A comprises polypropylene.

17. The film of claim 16, wherein the polypropylene is a terpolymer.

18. The film of claim 16, wherein the polypropylene is a random copolymer.

19. The film of claim 1, wherein the film has an overall thickness of about 5 to about 50 μm.

20. The film of claim 1, wherein the film further comprises a third layer C comprising a propylene-derived resin having a density of about 0.86 to about 0.91 g/cm³.

21. (canceled)

22. The film of claim 1, wherein the film is a shrink wrap film.

23. A method for forming a thermoplastic film comprising:
a) extruding an ethylene-derived resin to form an extrudate, wherein the ethylene-derived resin comprises:
(i) a compositional distribution breadth index (CDBI) of at least 50%;
(ii) a density of about 0.905 to about 0.945 g/cm³;
(iii) a melt index (MI) of about 0.1 to about 5.0 g/10 min;
(iv) a branching index (g′) of greater than about 0.7;
b) inflating the extrudate to form a first bubble;
i. cooling and collapsing the first bubble to form a primary tube;
ii. heating the primary tube;
iii. inflating the primary tube to form a second bubble, wherein the second bubble at least partially biaxially orients the film; and
iv. cooling and collapsing the second bubble.

24. The method of claim 23, further comprising extruding a propylene-derived resin with the ethylene-derived resin to form the extrudate.

25. The method of claim 23, wherein the propylene-derived resin is a polypropylene resin comprising at least 70 wt % of propylene based upon total weight of the resin and has a density of about 0.86 to about 0.91 g/cm³ and a MFR of about 0.5 to about 50.0 g/10 min.

26. (canceled)

27. A multilayer film formed using double bubble extrusion comprising:
a first propylene-derived skin layer and a second propylene-derived skin layer;
an ethylene-derived core layer located between the first propylene-derived skin layer and the second propylene-derived skin layer, the ethylene-derived core layer having:
(i) a compositional distribution breadth index (CDBI) of at least 50%;
(ii) a density of about 0.905 to about 0.945 g/cm³;
(iii) a branching index (g′) of greater than about 0.7; and wherein the film has:
(i) a Tensile at Break (MD/TD) of about 20 to about 200 MPa;
(ii) an Elongation at Break (MD/TD) of about 40 to about 200%; and
(iii) a 1% Secant Modulus (MD/TD) of about 300 to about 1000 MPa.
